(19) United States
(12) Patent Application Publication
(10) Pub. No.: US 2025/0306332 A1
(43) Pub. Date: Oct. 2, 2025

(54) ROTATIONAL MOVEMENT SUPPRESSION MECHANISM AND LENS DEVICE

(71) Applicant: FUJIFILM Corporation, Tokyo (JP)

(72) Inventors: Kazuaki OKAMORI, Saitama (JP); Yukihiro KANEKO, Saitama (JP); Satoru HORIKOSHI, Saitama (JP)

(73) Assignee: FUJIFILM Corporation, Tokyo (JP)

(21) Appl. No.: 19/090,372

(22) Filed: Mar. 25, 2025

(30) Foreign Application Priority Data
Mar. 27, 2024 (JP) 2024-051112

(51) Int. Cl. G02B 7/04

(52) U.S. Cl. CPC G02B 7/04

(57) ABSTRACT

A rotational movement suppression mechanism of an operation ring that is provided on an outer periphery of a fixed cylinder fixing an optical system and that is rotationally movable around an optical axis, includes: a fastening member that is provided on the operation ring, has a movement stroke in a direction intersecting the optical axis, and has a biasing portion at a distal end portion thereof; an intermediate barrel that suppresses rotational movement of the operation ring by pressure from the biasing portion; and a plurality of fixing members that fix the intermediate barrel to the fixed cylinder, in which the plurality of fixing members fix the intermediate barrel in a state where a gap is present between the intermediate barrel and the fixed cylinder, and fix the intermediate barrel to be movable with respect to the fixing member in a direction intersecting the optical axis.

### CROSS-REFERENCE TO RELATED APPLICATION

The present application claims priority under 35 U.S.C § 119 (a) to Japanese Patent Application No. 2024-051112 filed on Mar. 27, 2024, which is hereby expressly incorporated by reference, in its entirety, into the present application.

### BACKGROUND OF THE INVENTION

### 1. Field of the Invention

The present invention relates to a rotational movement suppression mechanism and a lens device, and particularly to a rotational movement suppression mechanism of an operation ring and a lens device comprising the rotational movement suppression mechanism.

### 2. Description of the Related Art

In the related art, a lens device in which a tripod mount is attached to a lens barrel is known.

For example, JP2017-76052A describes a lens device including a lens barrel to which a tripod mount is attached. The lens device of JP2017-76052A has a mechanism that suppresses rotational movement of an annular member with respect to the lens barrel by tightening the annular member in contact with an outer periphery of the lens barrel in an optical axis direction.

### SUMMARY OF THE INVENTION

An embodiment of the technology of the present disclosure is to provide a rotational movement suppression mechanism and a lens device that can suppress rotational movement of an operation ring, in a state where an influence on an optical system is reduced.

A rotational movement suppression mechanism according to a first aspect of the present invention is a rotational movement suppression mechanism of an operation ring that is provided on an outer periphery of a fixed cylinder fixing an optical system and that is rotationally movable around an optical axis, the rotational movement suppression mechanism including: a fastening member that is provided on the operation ring, has a movement stroke in a direction intersecting the optical axis, and has a biasing portion at a distal end portion thereof; an intermediate barrel that suppresses rotational movement of the operation ring by pressure from the biasing portion; and a plurality of fixing members that fix the intermediate barrel to the fixed cylinder, in which the plurality of fixing members fix the intermediate barrel in a state where a gap is present between the intermediate barrel and the fixed cylinder, and fix the intermediate barrel to be movable with respect to the fixing member in a direction intersecting the optical axis.

According to a second aspect of the present invention, in the rotational movement suppression mechanism of the first aspect, the plurality of fixing members are formed in a cylindrical shape, and a central axis of each of the plurality of fixing members is disposed in a direction intersecting the optical axis.

According to a third aspect of the present invention, in the rotational movement suppression mechanism of the first aspect, the gap is greater than an amount of displacement of a diameter of the intermediate barrel in a direction intersecting the optical axis in a case where the movement stroke is maximum.

According to a fourth aspect of the present invention, in the rotational movement suppression mechanism of the first aspect, the intermediate barrel is constituted by a first region having the gap and a second region that is in contact with the fixed cylinder.

According to a fifth aspect of the present invention, in the rotational movement suppression mechanism of the first aspect, the intermediate barrel is present between a body fitting diameter of the mount portion and a maximum diameter of the mount portion.

According to a sixth aspect of the present invention, in the rotational movement suppression mechanism of the first aspect, the plurality of fixing members are constituted by a first fixing member, and a second fixing member made of a material different from a material of the first fixing member.

According to a seventh aspect of the present invention, in the rotational movement suppression mechanism of the sixth aspect, a first contact portion of the first fixing member, which is in contact with the intermediate barrel, is formed of a resin, and a second contact portion of the second fixing member, which is in contact with the intermediate barrel, is formed of a metal.

According to an eighth aspect of the present invention, in the rotational movement suppression mechanism of the seventh aspect, the second contact portion and the intermediate barrel come into contact with each other in a case where a specified load is applied to the first contact portion.

According to a ninth aspect of the present invention, in the rotational movement suppression mechanism of the first aspect, the plurality of fixed members are constituted by two of the fixed members that are positioned in a rotationally asymmetric manner with respect to the optical axis.

According to a tenth aspect of the present invention, in the rotational movement suppression mechanism of the first aspect, the plurality of fixing members are constituted by three fixing members.

According to an eleventh aspect of the present invention, in the rotational movement suppression mechanism of the first aspect, the plurality of fixing members are positioned between a contact portion between the operation ring and the intermediate barrel.

According to a twelfth aspect of the present invention, in the rotational movement suppression mechanism of the first aspect, the operation ring includes a connecting portion for connection to a tripod mount.

A thirteenth aspect of the present invention is a lens device comprising the rotational movement suppression mechanism according to any one of the first aspect to the eleventh aspect.

### BRIEF DESCRIPTION OF THE DRAWINGS

FIG. 1 is an external view of a lens device comprising a rotational movement suppression mechanism.

FIG. 2 is a cross-sectional view of a lens device.

FIG. 3 is an enlarged view of a region II shown in FIG. 2.

FIG. 4 is an enlarged view of a fixing member shown in FIG. 2.

FIG. 5 is a cross-sectional view of the lens device.

FIG. 6 is a view showing a part of a cross section of the lens device in a Y-Z plane.

FIG. 7 is a view showing a part of a cross section of the lens device in the Y-Z plane.

FIG. 8 is a cross-sectional view of the lens device.

FIG. 9 is a cross-sectional view of the lens device.

FIG. 10 is a cross-sectional view of the lens device.

### DESCRIPTION OF THE PREFERRED EMBODIMENTS

Hereinafter, preferred embodiments of a rotational movement suppression mechanism and a lens device according to the embodiment of the present invention will be described with reference to the accompanying drawings.

First, a rotational movement suppression mechanism in the related art will be described.

In the related art, a rotational movement suppression mechanism that increases a frictional force with respect to a lens barrel by tightening a knob of a tripod mount ring of a lens device to suppress rotational movement of the tripod mount ring is known. Here, in the rotational movement suppression mechanism of the related art, in a case where the knob is strongly tightened in order to sufficiently exhibit the rotational movement suppression function of the tripod mount ring, a biasing force in a case where the knob is tightened to the optical member fixing barrel that holds the optical member may be applied. In a case where this biasing force is applied to the optical member fixing barrel, there is a problem in that the positional relationship of the optical system held by the optical member fixing barrel is changed, and the resolution performance of the lens device is deteriorated.

Therefore, in the rotational movement suppression mechanism according to the embodiment of the present invention, the intermediate barrel is provided between the tripod mount ring and the optical member fixing barrel, and the deformation of the intermediate barrel in a radial direction (the perfect circle is broken) due to the influence of the biasing force caused by the tightening of the knob is absorbed by the gap between the intermediate barrel and the optical member fixing barrel, and the deformation of the intermediate barrel is suppressed from causing the deformation of the optical member fixing barrel. Accordingly, in the rotational movement suppression mechanism 100 according to the embodiment of the present invention, it is possible to suppress a change in the positional relationship of the optical system held by the optical member fixing barrel 13 and to suppress deterioration in resolution performance.

Hereinafter, the rotational movement suppression mechanism according to the embodiment of the present invention will be described in detail.

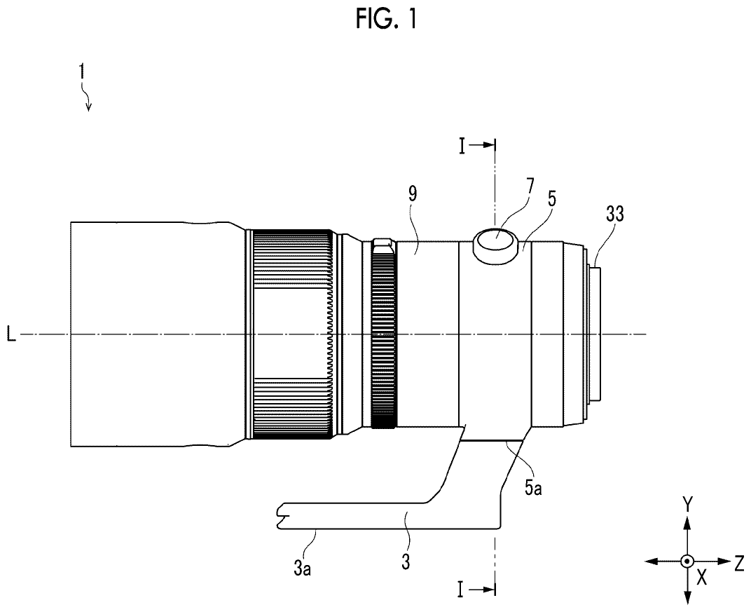

FIG. 1 is an external view of a lens device comprising a rotational movement suppression mechanism according to the embodiment of the present invention. In FIG. 1, an optical axis Lis shown.

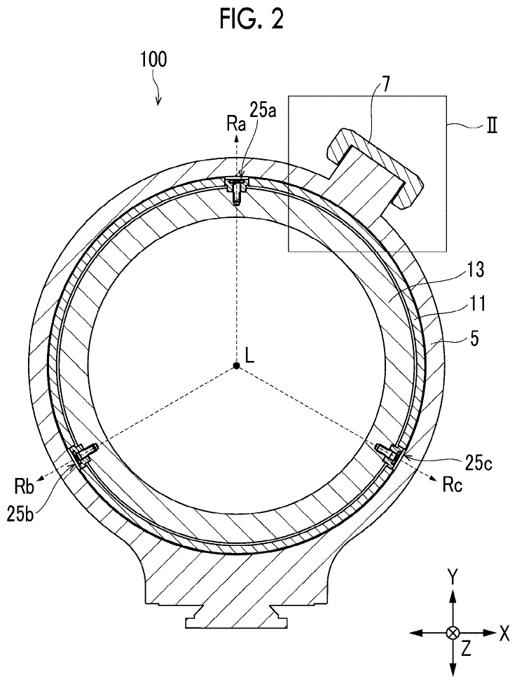

A camera body (not shown) is attached to the lens device 1 via a mount portion 33, and an image of a subject is captured. The lens device 1 includes a tripod mount ring (operation ring) 5 attached to the lens barrel 9. The tripod mount ring 5 is able to move rotationally around the optical axis L with respect to the outer periphery of the optical member fixing barrel 13 (see FIG. 2). The lens device 1 comprises a rotational movement suppression mechanism 100 (see FIG. 2) that suppresses rotational movement of the tripod mount ring 5.

The lens device 1 is connected to the tripod mount 3 via the tripod mount ring 5. The tripod mount ring 5 has a connection portion 5a for connection to the tripod mount 3. In the present example, the tripod mount ring 5 and the tripod mount 3 will be described using an example in which the tripod mount ring 5 and the tripod mount 3 are attachable and detachable, but the tripod mount ring 5 and the tripod mount 3 may be integrated. In addition, in the present example, the lens device 1 in which the tripod is attached to the connection portion 3a of the tripod mount 3 will be described as an example, but the application of the present invention is not limited to this example. For example, the present invention is also applied to the lens device 1 supported by a monopod instead of the tripod. In addition, the accessory is not particularly limited as long as it is an accessory fixed to the lens device 1, and the present invention is applied.

The tripod mount ring 5 is rotated and fastened by the knob (fastening member) 7 constituting a part of the rotational movement suppression mechanism 100, and thus the rotational movement with respect to the lens barrel 9 (or the intermediate barrel 11) is suppressed.

### First Embodiment

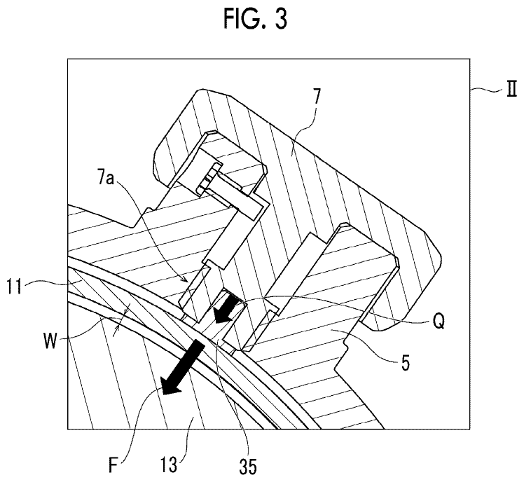

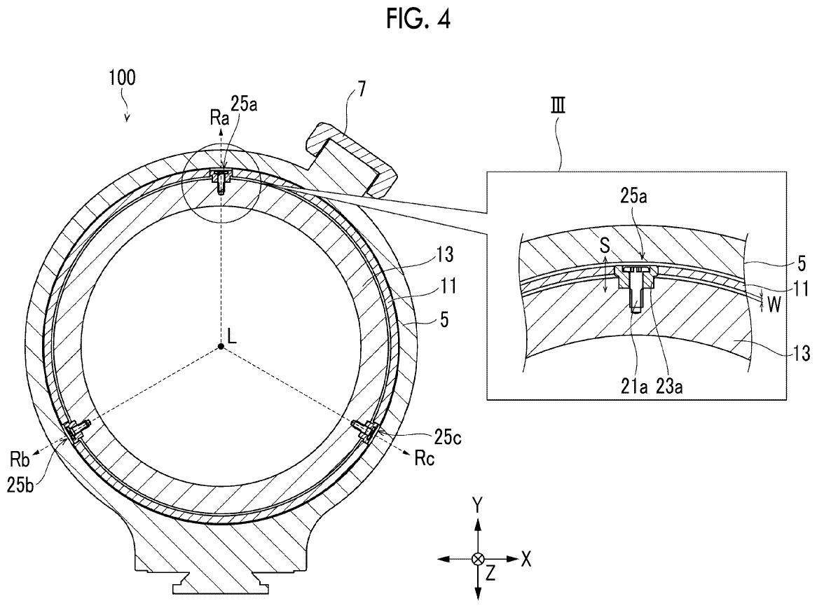

FIG. 2 is a cross-sectional view of the lens device 1 described in FIG. 1. FIG. 2 is a view showing the I-I cross section (cross section on the X-Y plane) shown in FIG. 1. In FIG. 2, only members necessary for the description of the rotational movement suppression mechanism 100 according to the embodiment of the present invention are shown, and the other members are not shown. In addition, a detailed structure of the inside of the knob 7 is omitted in FIG. 2. FIG. 3 is an enlarged view of the region II shown in FIG. 2, and FIG. 4 is an enlarged view III of the fixing member (first fixing member) 25 shown in FIG. 2.

The rotational movement suppression mechanism 100 provided in the lens device 1 suppresses rotational movement of the outer periphery of the optical member fixing barrel 13 of the tripod mount ring 5 around the optical axis. The rotational movement suppression mechanism 100 is composed of the knob 7, the intermediate barrel 11, a fixing bush (fixing member) 23, and a fixing screw (fixing member) 21.

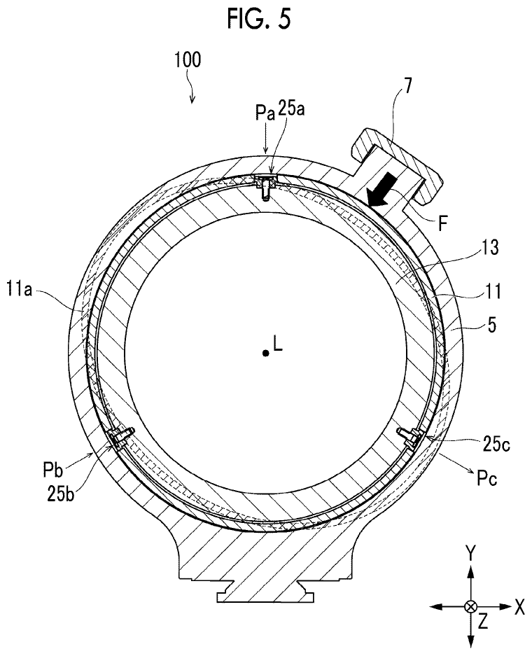

As shown in FIG. 2, the intermediate barrel 11 is provided between the tripod mount ring 5 and the optical member fixing barrel 13. Here, the optical member fixing barrel 13 fixes (holds) the optical system of the lens device 1 though the optical member fixing barrel 13 is not shown. The intermediate barrel 11 is pressed by a biasing portion 35 (see FIG. 3) provided at a distal end portion of the knob 7 provided in the tripod mount ring 5, and rotational movement of the tripod mount ring 5 is suppressed by a frictional force with the biasing portion 35. Here, the knob 7 is provided on the tripod mount ring 5. In a case where the knob 7 is rotated, a movement stroke Q, which is linearly moved by the screw feeding mechanism 7a fixed to the tripod mount ring 5, is provided in a direction intersecting the optical axis L (see FIG. 3). Then, a biasing force F acts on the intermediate barrel 11 by the biasing portion 35 provided at the distal end of the knob 7. For example, the biasing portion 35 is made of a resin. As the biasing force Fis stronger, a strong frictional force is generated between the biasing portion 35 and the intermediate barrel 11, and the rotational movement of the tripod mount ring 5 can be reliably suppressed. On the other hand, the intermediate barrel 11 may be deformed by receiving the biasing force F (for example, see FIG. 5). Therefore, in the rotational movement suppression mechanism 100, a state where a gap W (see FIG. 4) is provided between the intermediate barrel 11 and the optical member fixing barrel 13 is provided, and the deformation of the intermediate barrel 11 does not affect the optical member fixing barrel 13. For example, the gap W is provided to be larger than the amount of displacement of the intermediate barrel 11 in the direction intersecting the optical axis L in a case where the movement stroke Q of the knob 7 is the maximum. A gap W between the intermediate barrel 11 and the optical member fixing barrel 13 is shown in the enlarged view III shown in FIG. 4, and for example, the gap W is 0.1 mm or more.

The intermediate barrel 11 is provided in a state of having a gap W from the optical member fixing barrel 13 by three fixing members 25a to 25c. In the following description, the individual fixing members will be described as the fixing members 25a to 25c, and the fixing members will be described as the fixing member 25. The same applies to the other plurality of members.

The fixing member 25 is composed of the fixing bush 23 and the fixing screw 21. The three fixing members 25a to 25c are evenly disposed around the optical axis L. That is, the three fixing members 25a to 25c are disposed such that a central angle is 120° around the optical axis L. In this way, by fixing the fixing member 25 at three or more positions, the optical elements can be evenly disposed around the optical axis L. In addition, by evenly disposing the fixing members 25 around the optical axis L in this way, there is an advantage in terms of load resistance, and the damage to the fixing members 25 can be suppressed.

The fixing member 25a fixes the intermediate barrel 11 such that the intermediate barrel 11 has a degree of freedom in the radial direction Ra. The fixing member 25b fixes the intermediate barrel 11 such that the intermediate barrel 11 has a degree of freedom in the radial direction Rb. The fixing member 25c fixes the intermediate barrel 11 such that the intermediate barrel 11 has a degree of freedom in the radial direction Rc. That is, the fixing member 25 fixes the intermediate barrel 11 to the fixing member 25 to be movable in a direction intersecting the optical axis L. Specifically, the fixing bush 23 has a cylindrical shape, and the central axis of the cylinder is disposed in a direction intersecting the optical axis L, so that the intermediate barrel 11 and the fixing bush 23 can slide in a direction of an arrow S (see FIG. 4). Accordingly, the fixing member 25 can hold the intermediate barrel 11 such that a gap W is provided between the intermediate barrel 11 and the optical member fixing barrel 13, and in a case where the intermediate barrel 11 is deformed by the biasing force F of the biasing portion 35 due to the tightening of the knob 7, sliding occurs between the fixing bush 23 and the intermediate barrel 11, and the intermediate barrel 11 is deformed.

Next, the deformation of the intermediate barrel 11 will be described in a case where the knob 7 is tightened and the biasing force F from the biasing portion 35 is applied.

FIG. 5 is a cross-sectional view of the lens device 1 described in FIG. 1, and is a view for describing deformation of the intermediate barrel 11.

In a case where the knob 7 is tightened, the biasing force Facts on the intermediate barrel 11. Then, the intermediate barrel 11 is deformed due to the biasing force F. At a position of the arrow Pa, the intermediate barrel 11 is deformed to be contracted in the radial direction. At a position of the arrow Pb, the intermediate barrel 11 is deformed to be contracted in the radial direction. At a position of the arrow Pc, the intermediate barrel 11 is deformed to extend in the radial direction. As described above, in a case where the intermediate barrel 11 receives the biasing force F and has the degree of freedom in the radial direction in the fixing members 25a to 25c, the intermediate barrel 11 is changed from a circular shape to an elliptical shape, and in a case where the gap W is present, the deformation of the intermediate barrel 11 can be suppressed to the optical member fixing barrel 13.

As described above, according to the rotational movement suppression mechanism 100 according to the embodiment of the present invention, even in a case where the knob 7 is tightened, the intermediate barrel 11 and the optical member fixing barrel 13 are fixed by the fixing member 25 in a state where the gap W is provided between the intermediate barrel 11 and the optical member fixing barrel 13 to have a degree of freedom in the radial direction of the intermediate barrel 11. Therefore, even in a case where the intermediate barrel 11 is deformed, it is possible to suppress the deformation from extending to the optical member fixing barrel 13. Therefore, in the rotational movement suppression mechanism 100 according to the embodiment of the present invention, it is possible to suppress a change in the positional relationship of the optical system held by the optical member fixing barrel 13 and to suppress deterioration in resolution performance.

### Second Embodiment

Next, a second embodiment of the present invention will be described. In the present embodiment, at an end part of the intermediate barrel 11, a region where the intermediate barrel 11 is in contact with the optical member fixing barrel 13 is provided.

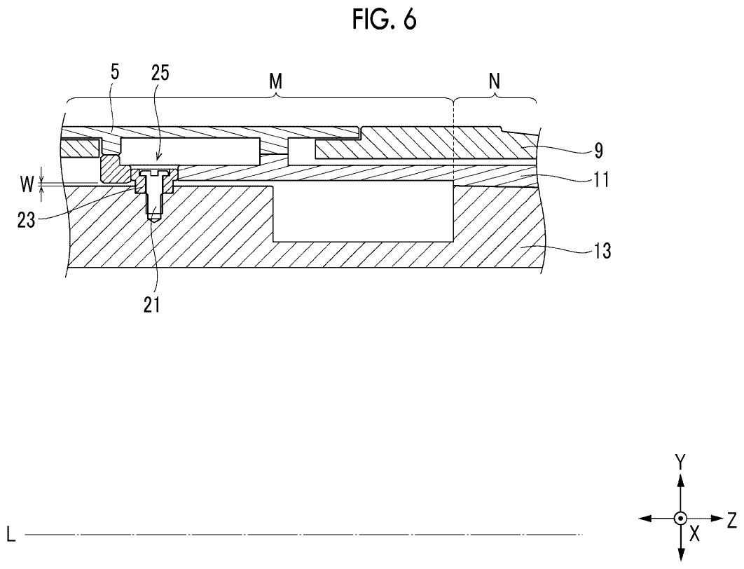

FIG. 6 is a view showing a part of a cross section of the lens device 1 shown in FIG. 1 in a Y-Z plane, and is a view showing the intermediate barrel 11 and the optical member fixing barrel 13 of the present embodiment. In FIG. 6, a part above the optical axis L is shown.

As shown in FIG. 6, the intermediate barrel 11 has a first region M having a gap W with the optical member fixing barrel 13 and a second region N in contact with the optical member fixing barrel 13. Here, the first region M is a region that is deformed by the biasing force F of the biasing portion 35 described above, and the gap W is provided between the optical member fixing barrel 13 and the first region M. Therefore, the deformation of the intermediate barrel 11 does not affect the optical member fixing barrel 13. On the other hand, since the second region N is in contact with the optical member fixing barrel 13, it is possible to suppress a core misalignment in a case where the fixing bush 23 is inserted and to suppress the deformation of the optical member fixing barrel 13 during assembly.

As described above, in the present embodiment, the intermediate barrel 11 has a region that is in contact with the region having the gap W with the optical member fixing barrel 13. Accordingly, it is possible to suppress the core misalignment in a case where the fixing bush 23 is inserted while suppressing the influence of the deformation of the intermediate barrel 11 on the optical member fixing barrel 13 and to suppress the deformation of the optical member fixing barrel 13 during assembly.

### Third Embodiment

Next, a third embodiment of the present invention will be described. In the present embodiment, the intermediate barrel 11 is present between a camera body (body) fitting diameter a of the mount portion 33 and a maximum diameter b of the mount portion 33.

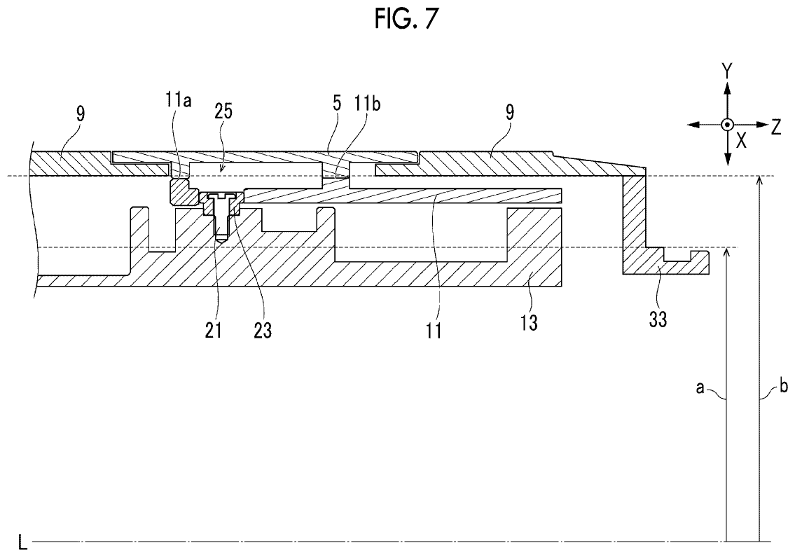

FIG. 7 is a view showing a part of a cross section of the lens device 1 shown in FIG. 1 in a Y-Z plane, and is a view showing the intermediate barrel 11 of the present embodiment. In FIG. 7, a portion above the optical axis L is shown.

As shown in FIG. 7, in the present embodiment, the intermediate barrel 11 is present between a body fitting diameter a of the mount portion 33 and a maximum diameter b of the mount portion 33. Here, the body fitting diameter a is a distance between an end part of a portion to which the body mounted on the mount portion 33 is fitted and the optical axis L. In addition, the maximum diameter b is a distance between the end part of the portion having the maximum radius of the mount portion 33 and the optical axis L. As described above, since the intermediate barrel 11 is present between the body fitting diameter a of the mount portion 33 and the maximum diameter b of the mount portion 33, the rotational movement suppression mechanism 100 can be reduced in size.

In addition, as shown in FIG. 7, it is preferable that the fixing member 25 is positioned between a contact portion 11a and a contact portion 11b of the intermediate barrel 11 and the tripod mount ring 5. In a case where the intermediate barrel 11 and the tripod mount ring 5 are in contact with each other in a part, it is preferable that the fixing member 25 is positioned to be interposed between the contact portion 11a and the contact portion 11b as shown in FIG. 7. Accordingly, the biasing force F can be stably applied to the intermediate barrel 11, and the fixing member 25 can stably fix the intermediate barrel 11.

### Fourth Embodiment

Next, a fourth embodiment of the present invention will be described. In the present embodiment, reinforcing fixing pins (second fixing members) 31a to 31b are provided.

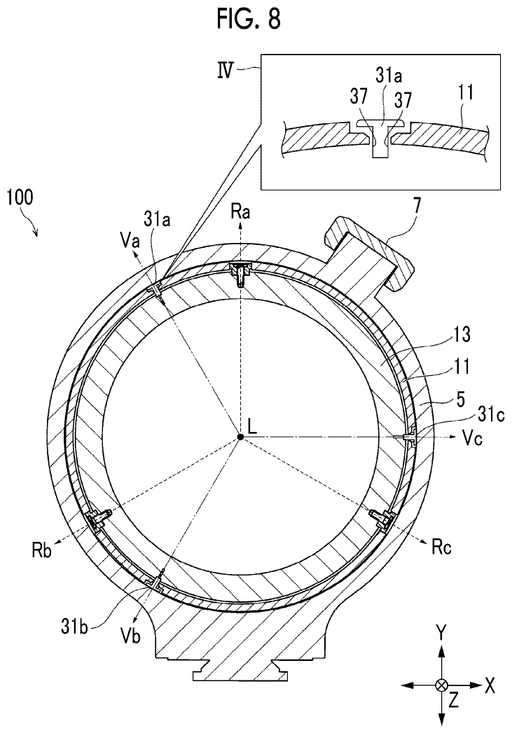

FIG. 8 is a cross-sectional view of the lens device 1 and is a view for describing a rotational movement suppression mechanism 100 of the fourth embodiment.

The rotational movement suppression mechanism 100 of the present embodiment is composed of the knob 7, the intermediate barrel 11, the fixing members 25a to 25c, and the reinforcing fixing pins 31a to 31c.

The reinforcing fixing pins 31a to 31c are disposed at equal intervals on a circumference centered on the optical axis L. That is, the reinforcing fixing pins 31a to 31c are disposed to have a central angle of 120° with the optical axis L as the center. In addition, the reinforcing fixing pins 31a to 31c are disposed at positions different from the fixing member 25. Specifically, the fixing members 25a to 25c and the reinforcing fixing pins 31a to 31c are disposed such that the radial directions Ra, Rb, and Rc and radial directions Va, Vb, and Vc are different from each other. Accordingly, the intermediate barrel 11 can be fixed more stably.

It is preferable that the reinforcing fixing pins 31a to 31c are made of a material different from the fixing bush 23 constituting the fixing member 25. For example, in a case where the fixing bush 23 is made of a resin, the reinforcing fixing pin 31 is made of a metal. Accordingly, even in a case where a large force acts on the intermediate barrel 11, the intermediate barrel 11 can be stably fixed by the reinforcing fixing pins.

It is preferable that the contact portions (second contact portions) 37 (see enlarged view IV in FIG. 8) of the reinforcing fixing pins 31a to 31c are disposed to be in contact with the intermediate barrel 11 in a case where a predetermined load is applied to the contact portions (first contact portions) of the fixing bush 23 and the intermediate barrel 11. Specifically, as shown in the enlarged view IV, the reinforcing fixing pins 31a and 31b are provided with a slight gap from the intermediate barrel 11. Accordingly, since the large deformation of the fixing member 25 is prevented, the rattling of the tripod mount ring 5 can be suppressed.

### Fifth Embodiment

Next, a fifth embodiment of the present invention will be described. In the present embodiment, two fixing members 25 are provided.

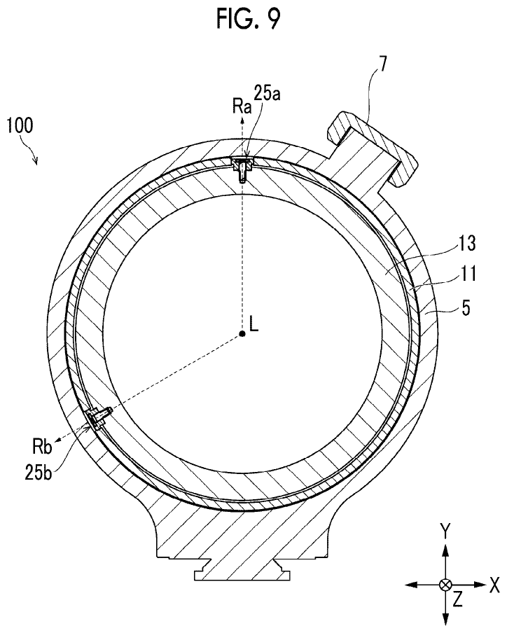

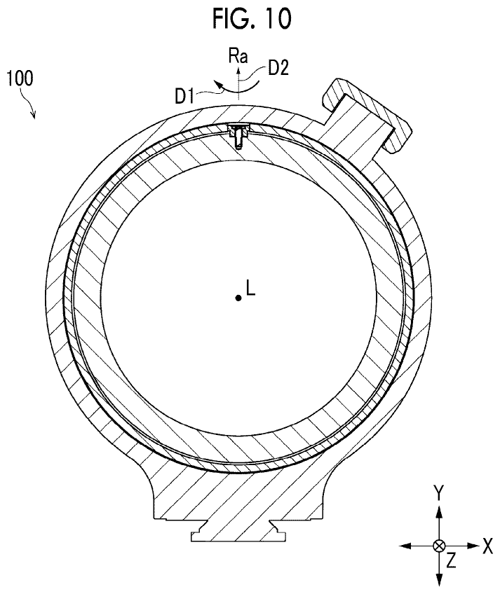

FIG. 9 is a cross-sectional view of the lens device 1 described in FIG. 1 and is a view for describing the rotational movement suppression mechanism 100 of the present embodiment. FIG. 10 is a cross-sectional view of the lens device 1 shown in FIG. 1 and is a view showing a case where one fixation member is provided.

The rotational movement suppression mechanism 100 is composed of the knob 7, the intermediate barrel 11, and the fixing members 25a and 25b.

The two fixing members 25a and 25b are composed of two fixing members 25 that are positioned in a rotationally asymmetric manner with respect to the optical axis L. That is, the fixing members 25a and 25b are disposed to have a positional relationship such that the two fixing members do not overlap each other at the same time even in a case where the fixing members are rotated (<) 360° around the optical axis L. Accordingly, even with the two fixing members 25, the intermediate barrel 11 can be geometrically restricted, and the intermediate barrel 11 can be fixed to the optical member fixing barrel 13.

In addition, in a case where one fixing member 25a is disposed as shown in FIG. 10, the intermediate barrel 11 cannot be fixed to the optical member fixing barrel 13 because there are degrees of freedom (two degrees of freedom) in the directions of D1 and D2.

As described above, according to the present embodiment, even in a case where the two fixing members 25a and 25b are disposed in a rotationally asymmetric relationship, the intermediate barrel 11 can be fixed to the optical member fixing barrel 13.

### Supplementary Note

The present disclosure also includes the following inventions.

### Aspect 1

A rotational movement suppression mechanism of an operation ring that is provided on an outer periphery of a fixed cylinder fixing an optical system and that is rotationally movable around an optical axis, the rotational movement suppression mechanism including: a fastening member that is provided on the operation ring, has a movement stroke in a direction intersecting the optical axis, and has a biasing portion at a distal end portion thereof; an intermediate barrel that suppresses rotational movement of the operation ring by pressure from the biasing portion; and a plurality of fixing members that fix the intermediate barrel to the fixed cylinder, in which the plurality of fixing members fix the intermediate barrel in a state where a gap is present between the intermediate barrel and the fixed cylinder, and fix the intermediate barrel to be movable with respect to the fixing member in a direction intersecting the optical axis.

### Aspect 2

The rotational movement suppression mechanism according to Aspect 1, in which the plurality of fixing members are formed in a cylindrical shape, and a central axis of each of the plurality of fixing members is disposed in a direction intersecting the optical axis.

### Aspect 3

The rotational movement suppression mechanism according to Aspect 1 or 2, in which the gap is greater than an amount of displacement of a diameter of the intermediate barrel in a direction intersecting the optical axis in a case where the movement stroke is maximum.

### Aspect 4

The rotational movement suppression mechanism according to any one of Aspects 1 to 3, in which the intermediate barrel is constituted by a first region having the gap and a second region that is in contact with the fixed cylinder.

### Aspect 5

The rotational movement suppression mechanism according to any one of Aspects 1 to 4, in which the intermediate barrel is present between a body fitting diameter of the mount portion and a maximum diameter of the mount portion.

### Aspect 6

The rotational movement suppression mechanism according to any one of Aspects 1 to 5, in which the plurality of fixing members are constituted by a first fixing member, and a second fixing member made of a material different from a material of the first fixing member.

### Aspect 7

The rotational movement suppression mechanism according to Aspect 6, in which a first contact portion of the first fixing member, which is in contact with the intermediate barrel, is formed of a resin, and a second contact portion of the second fixing member, which is in contact with the intermediate barrel, is formed of a metal.

### Aspect 8

The rotational movement suppression mechanism according to Aspect 7, in which the second contact portion and the intermediate barrel come into contact with each other in a case where a specified load is applied to the first contact portion.

### Aspect 9

The rotational movement suppression mechanism according to any one of Aspects 1 to 8, in which the plurality of fixed members are constituted by two of the fixed members that are positioned in a rotationally asymmetric manner with respect to the optical axis.

### Aspect 10

The rotational movement suppression mechanism according to any one of Aspects 1 to 9, in which the plurality of fixing members are constituted by three fixing members.

### Aspect 11

The rotational movement suppression mechanism according to any one of Aspects 1 to 10, in which the plurality of fixing members are positioned between a contact portion between the operation ring and the intermediate barrel.

### Aspect 12

The rotational movement suppression mechanism according to any one of Aspects 1 to 11, in which the operation ring includes a connecting portion for connection to a tripod mount.

### Aspect 13

A lens device including: the rotational movement suppression mechanism according to any one of Aspects 1 to 11.

Although the examples of the present invention have been described above, it is needless to say that the present invention is not limited to the embodiments described above and various modification examples can be made within a range not departing from the spirit of the present invention.

### EXPLANATION OF REFERENCES

1: lens device
3: tripod mount
5: tripod mount ring
7: knob
9: lens barrel
11: intermediate barrel
13: optical member fixing barrel
21: fixing screw
23: fixing bush
25: fixing member
31: reinforcing fixing pin
33: mount portion
35: biasing portion
37: contact portion
100: rotational movement suppression mechanism

What is claimed is:

1. A rotational movement suppression mechanism of an operation ring that is provided on an outer periphery of a fixed cylinder fixing an optical system and that is rotationally movable around an optical axis, the rotational movement suppression mechanism comprising:
a fastening member that is provided on the operation ring, has a movement stroke in a direction intersecting the optical axis, and has a biasing portion at a distal end portion thereof;
an intermediate barrel that suppresses rotational movement of the operation ring by pressure from the biasing portion; and
a plurality of fixing members that fix the intermediate barrel to the fixed cylinder,
wherein the plurality of fixing members fix the intermediate barrel in a state where a gap is present between the intermediate barrel and the fixed cylinder, and fix the intermediate barrel to be movable with respect to the fixing member in a direction intersecting the optical axis.

2. The rotational movement suppression mechanism according to claim 1,
wherein the plurality of fixing members are formed in a cylindrical shape, and a central axis of each of the plurality of fixing members is disposed in a direction intersecting the optical axis.

3. The rotational movement suppression mechanism according to claim 1,
wherein the gap is greater than an amount of displacement of a diameter of the intermediate barrel in a direction intersecting the optical axis in a case where the movement stroke is maximum.

4. The rotational movement suppression mechanism according to claim 1,
wherein the intermediate barrel is constituted by a first region having the gap and a second region that is in contact with the fixed cylinder.

5. The rotational movement suppression mechanism according to claim 1,
wherein the intermediate barrel is present between a body fitting diameter of the mount portion and a maximum diameter of the mount portion.

6. The rotational movement suppression mechanism according to claim 1,
wherein the plurality of fixing members are constituted by
a first fixing member, and
a second fixing member made of a material different from a material of the first fixing member.

7. The rotational movement suppression mechanism according to claim 6,
wherein a first contact portion of the first fixing member, which is in contact with the intermediate barrel, is formed of a resin, and a second contact portion of the second fixing member, which is in contact with the intermediate barrel, is formed of a metal.

8. The rotational movement suppression mechanism according to claim 7,
wherein the second contact portion and the intermediate barrel come into contact with each other in a case where a specified load is applied to the first contact portion.

9. The rotational movement suppression mechanism according to claim 1,
wherein the plurality of fixed members are constituted by two of the fixed members that are positioned in a rotationally asymmetric manner with respect to the optical axis.

10. The rotational movement suppression mechanism according to claim 1,
wherein the plurality of fixing members are constituted by three fixing members.

11. The rotational movement suppression mechanism according to claim 1,
wherein the plurality of fixing members are positioned between a contact portion between the operation ring and the intermediate barrel.

12. The rotational movement suppression mechanism according to claim 1,
wherein the operation ring includes a connecting portion for connection to a tripod mount.

13. A lens device comprising:
the rotational movement suppression mechanism according to claim 1.
